(19) United States
(12) Patent Application Publication
(10) Pub. No.: US 2014/0003224 A1
(43) Pub. Date: Jan. 2, 2014

(54) DETERMINISTIC NETWORK FAILURE DETECTION

(71) Applicants: Nicolas Guilbaud, Bondi NSW (AU); Libin Huang, Rhodes (AU)

(72) Inventors: Nicolas Guilbaud, Bondi NSW (AU); Libin Huang, Rhodes (AU)

(73) Assignee: GOOGLE INC., Mountain View, CA (US)

(21) Appl. No.: 13/535,330

(22) Filed: Jun. 27, 2012

(51) Int. Cl. H04L 12/26; H04L 29/14

(52) U.S. Cl. 370/216; 370/242

(57) ABSTRACT

Methods, systems, and apparatus, including computer programs encoded on computer storage media, for determining image search results. One of the methods includes storing data representing a collection of predetermined paths through a network of devices. One or more packets are transmitted along each of the predetermined paths, wherein each packet includes instructions for forwarding the packet along a distinct path of the predetermined paths. One or more of the transmitted packets are received. Two or more problem paths are identified using the transmitted packets and the received packets. A problem link between two network devices is determined based on a comparison of the problem paths.

### BACKGROUND

Interconnected network devices, e.g. routers and switches, receive and forward network packets according to routing protocols. For example, a router can use a selected routing protocol to direct a packet to a specific device. Different routing protocols can be used to direct communications within and outside a particular network.

### SUMMARY

In one aspect of the subject matter described in this specification, a plurality of predetermined paths through a network can be used to diagnose and deterministically identify problems in the network. A packet transmitted through a predetermined path (a “probe”) is used to detect problem links and devices within the network. Problem links and devices can be analyzed for common attributes in order to isolate and determine the source of the network problem.

In general, one innovative aspect of the subject matter described in this specification can be embodied in methods that include the actions of storing data representing a collection of predetermined paths through a network of devices, wherein each path comprises a sequence of network devices to forward a packet of data; transmitting one or more packets along each of the predetermined paths, wherein each packet includes instructions for forwarding the packet along a distinct path of the predetermined paths; receiving one or more of the transmitted packets; identifying two or more problem paths using the transmitted packets and the received packets; comparing the problem paths; and determining a problem link between two network devices based on a comparison of the problem paths. Other embodiments of this aspect include corresponding computer systems, apparatus, and computer programs recorded on one or more computer storage devices, each configured to perform the actions of the methods. A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions.

The foregoing and other embodiments can each optionally include one or more of the following features, alone or in combination. The actions include calculating a number of packets sent and a number of packets received. The network devices are routers configured to forward the packets along the predetermined paths. The actions include retransmitting a received packet along a same path in an opposite direction from a direction in which the packet was previously transmitted. Comparing the problem paths comprises determining a correlation or intersection between one or more attributes of the problem paths. A problem path is a path in which one or more packets transmitted along the path are received with latency that satisfies a threshold. A problem path is a path in which one or more packets transmitted along the path are not received within a threshold time period. Transmitting the one or more packets comprises transmitting the one or more packets from a device on an outer edge of the network. The actions include deriving the collection of predetermined paths from a database of network topology. The actions include varying a destination Internet Protocol address in each packet. The actions include determining a set of principal routers in the network; and determining each predetermined path from as a forwarding triplet of routers, wherein each forwarding triplet includes a principal router and two neighboring routers to the principal router.

Particular embodiments of the subject matter described in this specification can be implemented so as to realize one or more of the following advantages. Network monitoring using probes sent through predetermined paths provides the functionality to discover and to localize network problems deterministically rather than through trial and error. Deterministic probing can be used to identify network component failures before any observable service or application impact. Deterministic probing also provides the ability to test paths in the network before these paths are exposed to production traffic.

The details of one or more embodiments of the subject matter of this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 is a diagram of an example network.

FIG. 2 is a flowchart of an example process for determining paths in a network.

FIG. 3 is a flowchart of an example process for operating a network.

FIG. 4 is a flowchart of an example process for detecting network problems.

Like reference numbers and designations in the various drawings indicate like elements.

### DETAILED DESCRIPTION

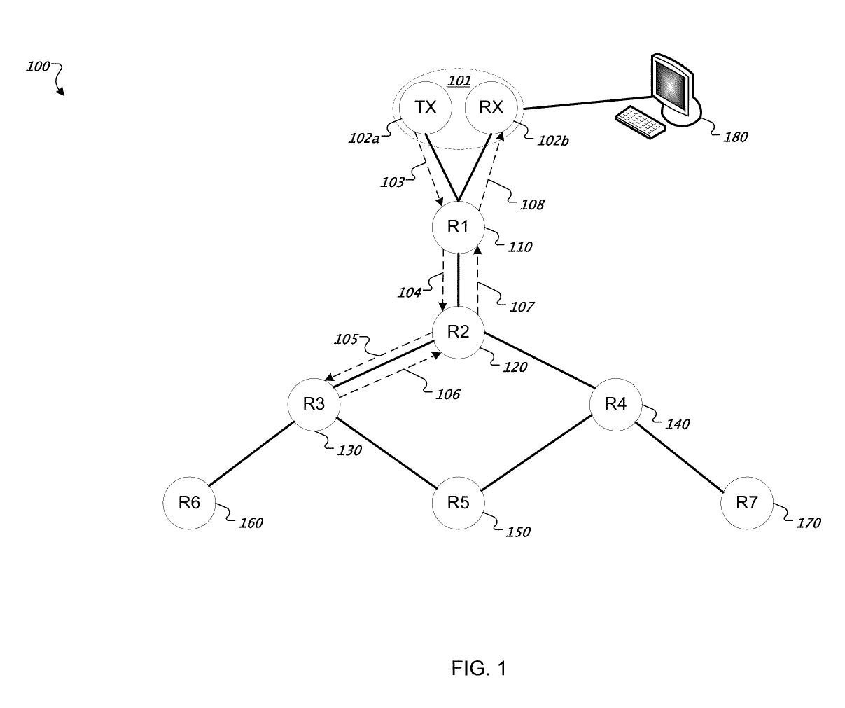

FIG. 1 is a diagram of an example network 100. The network 100 is an example of a network of interconnected devices that receive and forward packets of data. The network 100 can, for example, be a portion of a local area network (LAN) or wide area network (WAN), e.g., the Internet.

The network 100 includes network devices 110, 120, 130, 140, 150, 160, and 170 that can receive and forward network traffic. A monitoring device 180 can also be connected to the network 100 for diagnosing network problems. The network devices can be, for example, routers and switches. The monitoring device 180 can be any appropriate type of computing device, e.g., servers, mobile phones, tablet computers, notebook computers, music players, e book readers, laptop or desktop computers, PDAs, smart phones, or other stationary or portable device, that includes one or more processors and computer readable media. The network devices 110-170 can forward network traffic according to conventional routing protocols, including interior gateway protocols and exterior gateway protocols.

The network devices 110-170 can also receive and forward network packets according to a source routing protocol. A source routing protocol enables a sender of a network packet to specify a predetermined sequence of network devices, or a “path,” that the packet will take through the network. In contrast, with non-source routing protocols, routers in the network typically determine a path through the network based on the packet's destination. The path of a non-source routing protocol can change and may be unpredictable. In contrast, the sequence of devices specified by a source routing protocol can be encoded with or in the network packet itself.

A source routing protocol can be implemented, for example, by Multiprotocol Label Switching (MPLS). MPLS is a mechanism in which network data packets are assigned labels. Network devices can forward the labeled data packet along a path according to contents of the label. A path through an MPLS network is referred to as a Label Switched Path (LSP). LSPs can be implemented through a variety of protocols, for example, Resource Reservation Protocol (RSVP).

The network 100 can include many thousands of interconnected network devices. Thus, determining failures of individual devices can be difficult. The difficulty can be exacerbated if network administrators have access only to network devices on the outer edge of the network, as is commonly the case with a wide-area network. Because conventional routing protocols can reroute network traffic around a failed device, network administrators may only be aware of unexpected latency, without any insight into the cause of the problem. Similarly, an existing problem with a network device may go undetected for a particular period of time.

A source routing protocol can be used to diagnose network problems deterministically. Network problems and failed devices can be systematically isolated to one or more of a variety of attributes, for example, a connection between two network devices, a time of day, or a geographic location.

To diagnose network problems, a plurality of paths can be defined through the network of devices. A source device can transmit a packet of data along each of the defined paths, and a destination device can receive the transmitted packets. The destination device may or may not be the same device as the source device. The transmission of a packet from source device to a destination device through a predetermined path can be referred to as a “probe.” The path for a given probe can be implemented, for example, as an LSP. In some implementations, the LSP is strictly defined and static. As described above, the paths used to diagnose network problems can differ from paths taken by network traffic routed by conventional routing protocols. Furthermore, the defined paths need not be carrying any other network traffic.

The paths through the network can be derived in a variety of ways. In some implementations, administrators can compute one path from a monitoring device to each link to be tested in the network. Alternatively, administrators can compute all possible paths between routers in the network.

In some implementations, each path is designed to go through at least one of a set of routers in the network. For example, network administrators can design each path to go through a principal (“backbone”) router in the network. To define paths through a particular router, network administrators can define and maintain a set of “forwarding triplets” of three particular routers and two corresponding links, e.g. A<link1>B<link2>C, where “<link>” indicates a link between the routers. Fully-defined probe paths, e.g. LSPs, can then be defined based on the set of forwarding triplets. For example, a triplet itself can be a fully-defined path, or multiple triplets can be chained together to form a fully-defined path.

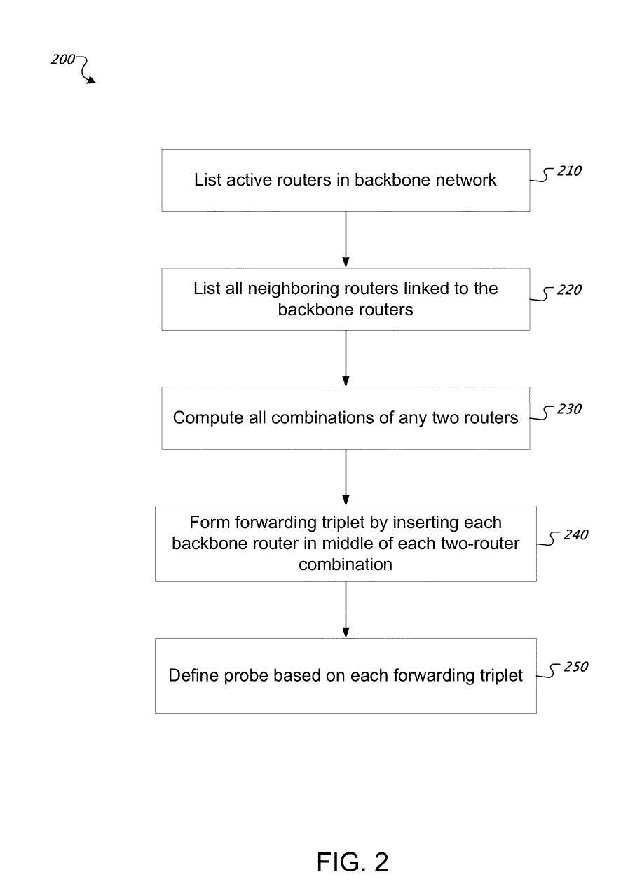

FIG. 2 is a flowchart of an example process 200 for determining a set of forwarding triplets in a network. The process 200 is an example process that can be used to define paths in a network for diagnosing network problems. The process 200 can be used to define paths based on forwarding triplets for a set of principal “backbone” routers in a network. The process 200 will be described as being performed by a computer system of one or more computers, for example, monitoring device 180 as shown in FIG. 1.

The system lists all active routers in the backbone network (210). For example, a network administrator can consider backbone routers to be principal routers in the network that carry a significant portion of network traffic.

The system lists all neighboring routers linked to the backbone routers (220). For example, the system can access a database of network topology to identify neighboring routers that are linked to the backbone routers. The system then computes all combinations of any two neighboring routers (230).

The system forms forwarding triplets by inserting each backbone router into the middle of each combination of two neighboring routers (240). Given a forwarding triplet, e.g. A⇄B⇄C, the system can then generate fully-defined probes, e.g. as LSPs, based on each forwarding triplet (250). The system can define the probes by computing the shortest path in the network between routers A or C in the forwarding triplet and the source or destination router. For example, a fully-defined probe can follow a shortest path from a source router to router A, then to router B, then to router C, and then a shortest path to the destination router from router C. Any appropriate path back from the source router to router A and from router C to the destination router can be used. In some cases, a forwarding triplet may not be possible to cover with a probe if, for example, a particular shortest path to router A or from router C cannot be found.

An example probe sent along a defined path is illustrated in FIG. 1 by a source device, router 102a, transmitting a packet of data along a predetermined path through the network of devices. The example probe can correspond to forwarding triplet R1⇄R2⇄R3. The packet follows an example path illustrated by arrow 103 from router 102a to router 110; arrow 104 from router 110 to router 120; arrow 105 from router 120 to router 130; arrow 106 from router 130 back to router 120; arrow 107 from router 120 back to router 110; and arrow 107 from router 110 to destination device 102b. In some implementations, the source device 102a and the destination device 102b can be on a same device 101.

A monitoring device can analyze packets received at the destination device 102b for attributes indicative of network problems, e.g., unexpected latency between when the packet was sent and when the packet was received. Additionally, the packet not being received by the destination device 102b within a threshold time period can indicate a network problem. The system can classify other probes with no unexpected problems as “clean.” By comparing probes for which a problem was detected, the system can deterministically identify problems in the network.

The following table illustrates an example of deterministically identifying a network problem using a plurality of probes that follow predetermined paths through a network based on forwarding triplets.

TABLE 1

| PROBE | FORWARDING TRIPLET | RESULT |
|---|---|---|
| 1 | TX<->R1<->RX | Clean |
| 2 | TX<->R1->R2 | Clean |
| 3 | R1<->R2<->R4 | Clean |
| 4 | R1<->R2<->R3 | Problem |
| 5 | R2<->R3<->R6 | Problem |
| 6 | R2<->R3<->R5 | Problem |
| 7 | R2<->R4<->R5 | Clean |
| 8 | R2<->R4<->R7 | Clean |
| 9 | R4<->R5<->R3 | Clean |
| 10 | R5<->R3<->R6 | Clean |

In this example, the monitoring device can analyze the data to deterministically identify that the link between router 120 (R2) and router 130 (R3) is down. Probes 4, 5, and 6 were identified as problem probes. Elements from the problem probes were as follows:

Probe 4: R1⇄R2⇄R3

Probe 5: R2⇄R3⇄R6

Probe 6: R2⇄R3⇄R5

The common element from these candidates is R2⇄R3. Therefore, the system can determine that a problem exists between router 120 (R2) and router 130 (R3).

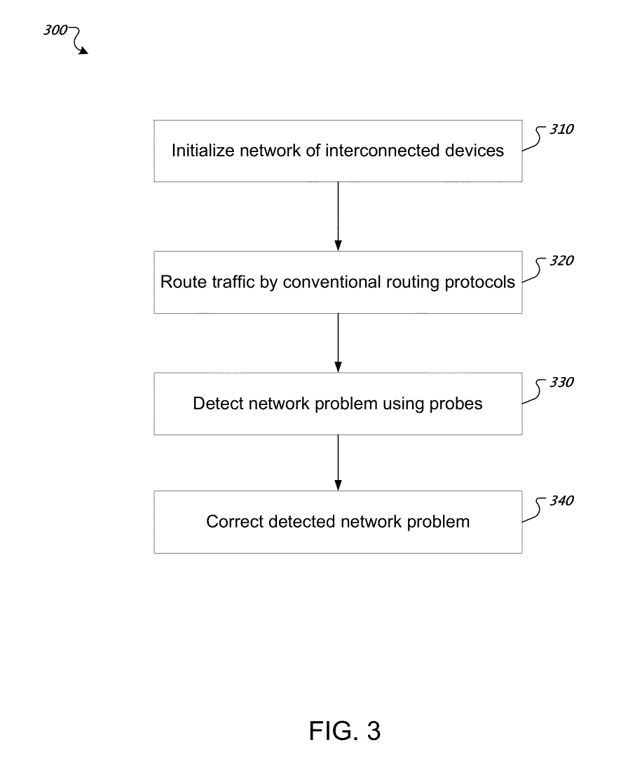

FIG. 3 is a flow chart of an example process 300 for operating a network. The process 300 can be performed using a network of interconnected devices, for example, the network 100 illustrated in FIG. 1. The process 300 can be performed by a network administrator or a computer system installed on one or more computers configured to manage a network of devices.

The system initializes a network of interconnected devices (310). The system can, for example, store information about connectivity of the network in a topology database. The topology database can be used to define forwarding triplets as described above.

The network routes traffic by conventional routing protocols (320). In some implementations, a subset of available routers, e.g. backbone routers, will handle a significant portion of total network traffic. Other routers may carry little or no network traffic, which can be the case, for example, when new routers are installed and being tested.

The system detects network problems using probes sent along deterministic paths (330). The system can periodically use probes to detect problems with currently-deployed network devices. Additionally, in the case of newly-installed routers, the system can use probes to test and diagnose problems with the newly-installed routers before burdening the new routers with production-level network traffic.

The detected network problem is corrected (340). Network administrators can, for example, quickly locate and repair or replace failed network devices by deterministically isolating the cause of network problems. Network administrators can also monitor the network over time to detect and correct problems that arise in network performance.

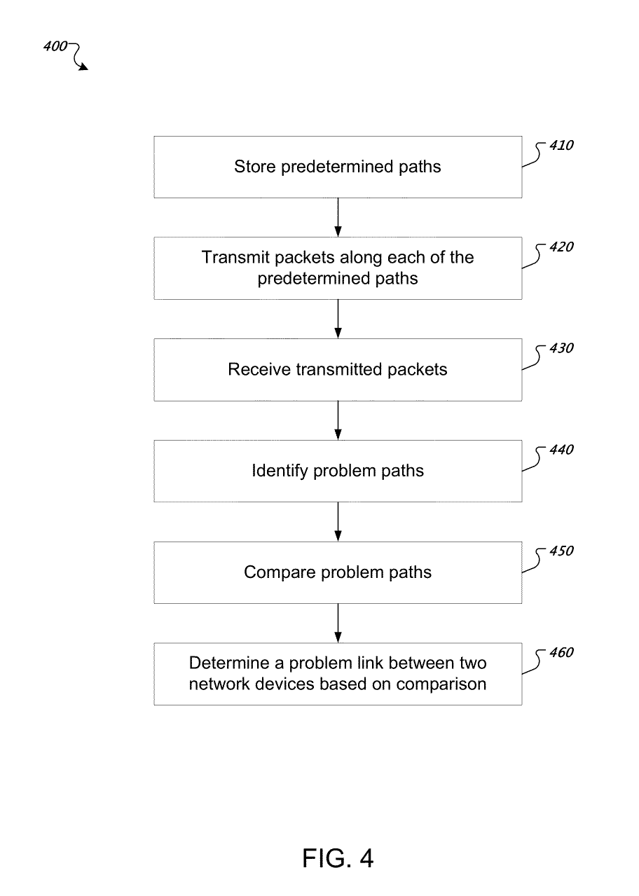

FIG. 4 is a flow chart of an example process 400 for detecting network problems. The process 400 can be implemented as a computer program installed on one or more computing devices connected to a network. For example, the process 400 can be performed by a monitoring device and a router that both sends and receives network packets. The process 400 will be described as being performed by a monitoring device and a router, e.g. monitoring device 180 and router 101 as shown in FIG. 1.

The monitoring device stores data representing a collection of predetermined paths (410). For example, the stored data for each path can specify a sequence of routers in a network. The monitoring device can derive the predetermined paths from a database of network topology, for example, as described above with respect to FIG. 2.

The router transmits packets of data along each of the predetermined paths (420). The packets can be transmitted according to a source routing protocol that defines the sequence of network devices that will forward each packet. The router receives one or more of the transmitted packets (430). In some implementations, a different device receives the transmitted packets. The router can also retransmit received packets along the reverse of the predetermined path to test both directions of the path. The router can also vary destination Internet Protocol addresses in the transmitted packets in order to exercise all switches between two particular routers.

The monitoring device identifies problem paths (440). After receiving the transmitted packets, the monitoring device can analyze the received packets to identify problem paths. Problem paths can be paths for which unexpected latency is observed. For example, if a transmitted packet is received after a time period that satisfies a threshold, the monitoring device can designate the path as a problem path. In some cases, the router may not receive a transmitted packet. The monitoring device can consider packets not received within a threshold time period to be dropped packets and can designate the path as a problem path accordingly.

The monitoring device compares the problem paths (450). Many attributes of the problem paths can be recorded when the problem path is identified. In addition to the path taken by the transmitted packet, the monitoring device can record a time of day, a day of the week, and a geographic location for each problem path, in addition to others.

The monitoring device determines a problem link between two network devices based on the comparison (460). The monitoring device can, for example, identify one or more common attributes of the problem paths in order to determine a problem link. For example, the monitoring device can determine that a specific link between two network devices is down. Additionally, the monitoring device can determine that a link between two network devices is a problem on Saturdays at 10 a.m.

The monitoring device can use several techniques for analyzing the problem paths and determining a problem link. In some implementations, the monitoring device can compute an intersection or a correlation to determine common attributes of problem paths.

The monitoring device can also monitor the paths periodically to determine changes in path quality over time. For example, if the latency of a path over time gradually and steadily increases, the monitoring device can determine that a particular link on the path may be likely to fail in the future. Similarly, the monitoring device can monitor the paths to determine a recurring problematic time period for the network's performance. For example, the monitoring device can monitor the paths and determine that problem paths arise during a particular day of the week or in a particular building or other geographic location.

The monitoring device can also use a rating algorithm to identify how the quality of a link degrades with time. For example, the monitoring device can analyze all paths that traversed a particular link in the network and count how many paths through that link were problem paths. If the count of problem paths through that particular link increases with time, the monitoring device can determine that the quality of the link is degrading over time and that the link may be likely to fail in the future.

In addition to diagnosing problems in networks, monitoring with deterministic probes can also be used to identify and diagnose problems in many other kinds of node and edge based systems, including power grids, circuit boards, and pipelines, for example.

Embodiments of the subject matter and the functional operations described in this specification can be implemented in digital electronic circuitry, in tangibly-embodied computer software or firmware, in computer hardware, including the structures disclosed in this specification and their structural equivalents, or in combinations of one or more of them. Embodiments of the subject matter described in this specification can be implemented as one or more computer programs, i.e., one or more modules of computer program instructions encoded on a tangible non-transitory program carrier for execution by, or to control the operation of, data processing apparatus. Alternatively or in addition, the program instructions can be encoded on an artificially-generated propagated signal, e.g., a machine-generated electrical, optical, or electromagnetic signal, that is generated to encode information for transmission to suitable receiver apparatus for execution by a data processing apparatus. The computer storage medium can be a machine-readable storage device, a machine-readable storage substrate, a random or serial access memory device, or a combination of one or more of them.

The term “data processing apparatus” encompasses all kinds of apparatus, devices, and machines for processing data, including by way of example a programmable processor, a computer, or multiple processors or computers. The apparatus can include special purpose logic circuitry, e.g., an FPGA (field programmable gate array) or an ASIC (application-specific integrated circuit). The apparatus can also include, in addition to hardware, code that creates an execution environment for the computer program in question, e.g., code that constitutes processor firmware, a protocol stack, a database management system, an operating system, or a combination of one or more of them.

A computer program (which may also be referred to or described as a program, software, a software application, a module, a software module, a script, or code) can be written in any form of programming language, including compiled or interpreted languages, or declarative or procedural languages, and it can be deployed in any form, including as a stand-alone program or as a module, component, subroutine, or other unit suitable for use in a computing environment. A computer program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub-programs, or portions of code. A computer program can be deployed to be executed on one computer or on multiple computers that are located at one site or distributed across multiple sites and interconnected by a communication network.

The processes and logic flows described in this specification can be performed by one or more programmable computers, e.g. monitoring device 180, executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application-specific integrated circuit).

Computers suitable for the execution of a computer program include, by way of example, can be based on general or special purpose microprocessors or both, or any other kind of central processing unit. Generally, a central processing unit will receive instructions and data from a read-only memory or a random access memory or both. The essential elements of a computer are a central processing unit for performing or executing instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device, e.g., a universal serial bus (USB) flash drive, to name just a few.

Computer-readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

Embodiments of the subject matter described in this specification can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation of the subject matter described in this specification, or any combination of one or more such back-end, middleware, or front-end components. The components of the system can be interconnected into a network, e.g. network 100, by any form or medium of digital data communication, e.g., a communication network. Examples of communication networks include a local area network (“LAN”) and a wide area network (“WAN”), e.g., the Internet.

The computing system can include clients and servers. A client and server are generally remote from each other and typically interact through a communication network. The relationship of client and server arises by virtue of computer programs running on the respective computers and having a client-server relationship to each other.

While this specification contains many specific implementation details, these should not be construed as limitations on the scope of any invention or of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In certain implementations, multitasking and parallel processing may be advantageous.

What is claimed is:

1. A computer-implemented method comprising:
storing data representing a collection of predetermined paths through a network of devices, wherein each path comprises a sequence of network devices to forward a packet of data;
transmitting one or more packets along each of the predetermined paths, wherein each packet includes instructions for forwarding the packet along a distinct path of the predetermined paths;
receiving one or more of the transmitted packets;
identifying two or more problem paths using the transmitted packets and the received packets;
comparing the problem paths; and
determining a problem link between two network devices based on a comparison of the problem paths.

2. The method of claim 1, further comprising:
calculating a number of packets sent and a number of packets received.

3. The method of claim 1, wherein the network devices are routers configured to forward the packets along the predetermined paths.

4. The method of claim 1, further comprising:
retransmitting a received packet along a same path in an opposite direction from a direction in which the packet was previously transmitted.

5. The method of claim 1, wherein comparing the problem paths comprises determining a correlation or intersection between one or more attributes of the problem paths.

6. The method of claim 1, wherein a problem path is a path in which one or more packets transmitted along the path are received with latency that satisfies a threshold.

7. The method of claim 1, wherein a problem path is a path in which one or more packets transmitted along the path are not received within a threshold time period.

8. The method of claim 1, wherein transmitting the one or more packets comprises transmitting the one or more packets from a device on an outer edge of the network.

9. The method of claim 1, further comprising deriving the collection of predetermined paths from a database of network topology.

10. The method of claim 1, further comprising:
varying a destination Internet Protocol address in each packet.

11. The method of claim 1, further comprising:
determining a set of principal routers in the network; and
determining each predetermined path from as a forwarding triplet of routers, wherein each forwarding triplet includes a principal router and two neighboring routers to the principal router.

12. A system comprising:
one or more network devices that are each configured to receive a packet and forward the packet along a distinct predetermined path, wherein each path comprises a sequence of network devices to receive and forward the packet; and
one or more computers configured to perform operations comprising:
storing data representing a collection of predetermined paths through the one or more network devices;
transmitting one or more packets along each of the predetermined paths;
receiving one or more of the transmitted packets;
identifying two or more problem paths using the transmitted packets and the received packets;
comparing the problem paths; and
determining a problem link between two network devices based on a comparison of the problem paths.

13. The system of claim 12, wherein the network devices are routers configured to forward the packets along the predetermined paths.

14. The system of claim 12, wherein the operations further comprise:
retransmitting a received packet along a same path in an opposite direction from a direction in which the packet was previously transmitted.

15. The system of claim 12, wherein comparing the problem paths comprises determining a correlation or intersection between one or more attributes of the problem paths.

16. The system of claim 12, wherein a problem path is a path in which one or more packets transmitted along the path are received with latency that satisfies a threshold.

17. The system of claim 12, wherein a problem path is a path in which one or more packets transmitted along the path are not received within a threshold time period.

18. The system of claim 12, wherein transmitting the one or more packets comprises transmitting the one or more packets from a device on an outer edge of the network.

19. The system of claim 12, wherein the operations further comprise deriving the collection of predetermined paths from a database of network topology.

20. A computer program product, encoded on one or more non-transitory computer storage media, comprising instructions that when executed by one or more computers cause the one or more computers to perform operations comprising:
storing data representing a collection of predetermined paths through a network of devices, wherein each path comprises a sequence of network devices to forward a packet of data;
transmitting one or more packets along each of the predetermined paths, wherein each packet includes instructions for forwarding the packet along a distinct path of the predetermined paths;
receiving one or more of the transmitted packets;
identifying two or more problem paths using the transmitted packets and the received packets;
comparing the problem paths; and
determining a problem link between two network devices based on a comparison of the problem paths.
